(19) United States
(12) Patent Application Publication
(10) Pub. No.: US 2024/0017597 A1
(43) Pub. Date: Jan. 18, 2024

(54) FRESH AIR MEANS

(71) Applicant: JOSEPH VOEGELE AG, Ludwigshafen/Rhein (DE)

(72) Inventors: Bernhard ERDTMANN, Edingen Neckarhausen (DE); Stefan WEBER, Roedersheim-Gronau (DE); Helmut KESSLER, Kaiserslautern (DE); Johannes PONTIUS, Schmelz (DE); Jan RIFFEL, Mannheim (DE)

(73) Assignee: JOSEPH VOEGELE AG, Ludwigshafen/Rhein (DE)

(21) Appl. No.: 18/221,266

(22) Filed: Jul. 12, 2023

(30) Foreign Application Priority Data
Jul. 14, 2022 (EP) 22184913.6

(51) Int. Cl. B60H 3/06; B60H 1/00

(52) U.S. Cl. CPC B60H 3/0658; B60H 1/00295; B60H 1/00357; B60H 1/00521

(57) ABSTRACT

The disclosure relates to a fresh air means or device for a driver control panel or for an external control console of a road making machine which is configured in the form of a road finishing machine or a charger vehicle for a road finishing machine. The fresh air means comprises at least one blower unit for generating an air flow, at least one filter unit for filtering the air flow formed by means of the blower unit, and an air discharge unit including at least one air outlet opening for the filtered air flow. Furthermore, fresh air means is designed as a modular attachment apparatus configured to be removably attached to the driver control panel or to the external control console.

### CROSS REFERENCE TO RELATED APPLICATIONS

This application claims foreign priority benefits under 35 U.S.C. § 119(a)-(d) to European patent application number EP 22184913.6, filed Jul. 14, 2022, which is incorporated by reference in its entirety.

### TECHNICAL FIELD

The present disclosure relates to a fresh air means or device for a driver control panel or for an external control console of a road making machine.

### BACKGROUND

It is known that at road making machines, in particular at a road finishing machine, suction systems are employed for laying a new asphalt layer which in particular suck off fumes produced during the transverse distribution of the hot laying material performed in an auger space positioned in front of the screed and eject them above the driver control platform of the road finishing machine. Such a suction system is disclosed in EP 0 843 044 A1.

By this suction system, fumes are only sucked off in the auger space between the machine's rear wall and the screed's front wall. As soon as the screed extends, the material feed in front of the screed is also “extended” and is now located next to the machine and thus outside of the region covered by the suction system. Thus, fumes reach the region of an external control platform of the screed where an operator is located during the installation of the new asphalt layer.

Furthermore, at road finishing machines, fumes are also produced in the region of the material bunker in which the hot laying material is stocked, fumes to which in particular a driver of the road finishing machine is exposed. In order to suck off these fumes, EP 0 843 044 A1 proposes a further suction means. This suction means, too, ejects the fumes sucked off from the material bunker region above the roof. However, in this device here, it may also occur that not all fumes can be sucked off from the material bunker and thus, a portion thereof can optionally stream into the region of the driver control platform where the driver of the road making machine is positioned.

DE 10 2020 123 723 A1 discloses a road finishing machine with a control platform having an air nozzle unit which is designed to create an air curtain around the control platform. The air nozzle unit may be integrated in a roof of the control platform. The air nozzle unit is to form an air wall from the roof, from the top to the bottom, along an open side of the driver control platform.

The above-described suction/blower systems cause high construction efforts mainly due to their integrated design. In particular, different suction/blower systems thereby arise for various machine types. Across all series, various special manufactures are thus developed, thereby increasing manufacturing costs.

CN 211 571 280 U discloses a road finishing machine in which a fresh air means is fastened to the roof of the driver control platform. However, this device involves the disadvantage that only contaminated air accumulated below the roof can be purified, this means, the operator positioned below it very probably only slightly benefits from it.

### SUMMARY

It is an object of the disclosure to provide a device for improving the air quality in the region of the operating personnel of a road making machine that can be manufactured in an inexpensive manner and can be broadly and effectively employed.

The disclosure relates to a fresh air means or device for a driver control panel or for an external control console of a road making machine which is configured in the form of a road finishing machine or a charger vehicle for a road finishing machine. The fresh air means according to the disclosure comprises at least one blower unit for generating an air flow, at least one filter unit for filtering the air flow formed by means of the blower unit, and an air discharge unit which includes at least one air outlet opening for the filtered air flow.

According to the disclosure, the fresh air means is designed as a modular attachment apparatus configured to be removably attached to the driver control panel or to the external control console. Thus, the fresh air means according to the disclosure can be employed as a separate function unit for forming the air barrier, i.e., independently of the operation of a blower and/or suction component integrated in the road making machine and in particular used for sucking off fumes from the spiral space. Compared to such blower and/or suction components already integrated in the road making machine, the fresh air means according to the disclosure forms an off-grid attachment module which can be easily mounted by the operator on site, independent of the present machine types of the road making machine, that means across all series. This means that the fresh air means according to the disclosure can be employed as an off-grid attachment module as a standard at different road making machines, that means it is broadly applicable, and consequently, manufacturing costs can also be reduced.

The fresh air means according to the disclosure forms a standard and retrofit module attachable to various machine types which, despite its standardized modular construction, has a high potential for an individual application at the road making machine. In particular, the fresh air means according to the disclosure can be individually adjusted by the operator thanks to its modular construction and its off-grid functioning without the operator having to adjust components integrated in the machine to this end. Basically, it is possible to set up an operation independent between the fresh air means according to the disclosure and other machine components, that means to have them running in an isolated manner.

Furthermore, the fresh air means according to the disclosure can be easily detached from the road making machine as a whole, i.e., as a modular unit, due to its removable attachment. For example, the fresh air means can be deinstalled overnight, during transport drives, for service and/or cleaning purposes, with only a few movements of the hands.

The fresh air means according to the disclosure forms, mainly as a modular attachment apparatus, a compact module that can be altogether fastened to the road finishing machine in a compact design and easily visibly, whereby its operability can also be easily checked.

By it being possible to attach the fresh air means according to the disclosure removably at the driver control panel or at the external control console, in particular directly at operation units used by the driver or by an operator, the fresh air generated by the fresh air means is selectively provided at the place where it is required by the driver or the operator. Thereby, an improvement of the air quality is directly provided at the place of the driver or the operator, respectively.

Preferably, the blower unit includes a centrifugal fan. The latter can suck in air axially along its motor axis and blows out the air offset about 90°. Such a centrifugal fan has a high efficiency and is above all suited for upstream and/or downstream units connected to it which operate with increased compressions and air pressures, respectively, for example, for an upstream filter. Moreover, the centrifugal fan is suited for low-noise operation. It would be conceivable for the blower unit to include an axial-flow fan instead of a centrifugal fan. Due to its functioning of axially sucking in air and axially ejecting it, there is a potential for an advantageous, constructive design.

In one variant, the blower unit includes an electric motor. This is in particular a speed-controlled electric motor. To this end, the motor could be equipped with a separate speed control module, so that a separate operation of the blower unit can be even better adjusted individually.

According to one embodiment of the disclosure, the blower unit can be connected with a power supply source of the road making machine. It would be conceivable for the fresh air means to include a power plug which can be connected with a socket mounted at the road making machine to supply the blower unit with power.

Preferably, the fresh air means includes at least one own accumulator (e.g., battery), for example a lithium-ion accumulator, for an operation of the blower unit. Concerning power supply, the fresh air means would thus be designed to be completely off-grid. In one variant, the accumulator can be charged by means of the power supply source of the road making machine.

According to an advantageous embodiment of the disclosure, the air discharge unit comprises at least one operating element for adjusting a speed of the blower unit. It would be conceivable for at least one function of the fresh air means, in particular the speed of the blower unit, to be controllable at an operating surface of the driver control panel or at an operating surface of the external control console, for example via a WLAN, Ethernet and/or Bluetooth connection that can be established between the fresh air means and the driver control panel or the external control console.

In this context, it would be possible for a dynamic speed control of the electric motor of the blower unit to be accomplished depending on one or several measured process values during the operation of the road making machine. This function can be activated, for example, by means of the operating surface of the driver control panel or by means of the operating surface of the external control console. The dynamic speed control, however, could also be directly activated at the fresh air means.

In a simple variant, at least two power stages for the operation of the blower unit can be directly activated at the fresh air means. It would be conceivable to directly equip the fresh air means with a separate operating module. This operating module could comprise a display for displaying adjusted operating parameters of the fresh air means, the display being configured, according to a particular embodiment, as a touch display for controlling and/or monitoring an operation of the fresh air means.

According to one embodiment, a driver or an operator, respectively, could control the fresh air means by means of a mobile unit, for example by means of a smart device. The smart device can be designed in the form of a smartphone, a tablet PC, wearables and/or data goggles.

According to one embodiment of the disclosure, the fresh air means is configured for a networked operation with at least one other attachment module attached to the road making machine, for example with a thermographic module and/or a weather module. It would in particular be possible for the speed control of the blower unit to be accomplished as a function of at least one process value measured at the other attachment module. For example, a temperature of the fresh air flow can be dynamically adapted depending on an ambient temperature of the road making machine measured by means of the weather module. For this, a heating/cooling element integrated in the fresh air means could be used.

According to one variant of the disclosure, the filter unit is positioned upstream of the blower unit seen in the direction of flow. Thereby, the air sucked in by means of the blower unit is purified before it passes the blower unit, whereby the blower unit can be better protected from contaminations. This variant is particularly suited together with the use of a centrifugal fan because the filter unit can be, on the one hand, easily integrated in its axial airstream, and on the other hand, high filtration is also possible. As an alternative, it would also be conceivable to position the filter unit or a further filter unit of the blower unit downstream in the direction of flow. Such a variant would above all be possible when the blower unit is configured as an axial-flow fan.

A variant would be conceivable in which the blower unit is positioned between at least one upstream filter unit designed as a coarse filter, and at least one downstream filter unit designed as a fine filter. Thereby, several positive effects can be achieved at once. The upstream coarse filter or filters take care of a gentle operation of the blower unit, and the downstream fine filter or filters take care of an optimal air quality.

Preferably, the filter unit includes a filter housing for receiving at least one replaceable filter element. It would generally be conceivable to equip the fresh air means with an hour meter or at least functionally connect it with such an hour meter, wherein an operator or driver, respectively, can be requested, depending on an operating hours status reached by it, to perform service or cleaning intervals, for example to replace the filter element installed in the filter housing by a new one.

According to one variant of the disclosure, the filter element is an activated-carbon filter. Preferably, two filter elements designed as activated-carbon filters are positioned one behind the other in the filter housing. Thereby, bituminous fumes can be particularly effectively filtered from the air. An arrangement would be conceivable in which two filter elements designed as activated-carbon filters are positioned upstream of the blower unit in series, and at least one further filter element designed as an activated-carbon filter is positioned downstream of the blower unit.

It would be advantageous for the filter unit to provide at least one housing expansion stage for the filter housing by means of which at least one further filter element, for example an activated-carbon filter, can be received. It would be possible thereby to create a housing volume in which a plurality of filter elements can be received. Preferably, the filter elements are positioned in series within the expanded filter housing one behind the other in the direction of flow. Thereby, contaminations can be even better filtered from the sucked-in air. The filter elements arranged one behind the other can even include different filter properties, in particular form filtration stages that are getting finer.

In particular, the housing expansion stage could be configured to receive, apart from the filter element or the further filter elements, also at least one other front unit or front component, respectively, for example a dust protection and/or a protective grid.

It would be conceivable for the filter housing, including the housing expansion stage optionally provided for it, to be substantially made of plastic. This proves advantageous for a lightweight construction. In particular, the filter housing can be composed of a plurality of plastic shells.

According to one variant, the filter housing, in particular together with the housing expansion stage attachable thereto, can be assembled without tools, for example using quick locks. An exchange of the filter element or elements received therein can thus be easily performed by the driver or the operator on site, respectively, that means with only a few movements of the hands.

Preferably, the air discharge unit includes a mounting plate to which the blower unit and/or the filter unit is fastened. The blower unit and the filter unit can be arranged on opposed sides of the mounting plate. The mounting plate forms a stable fastening base for the blower unit and/or the filter unit fastened to which the blower unit and the filter unit can be stably oriented in particular with respect to each other.

In a particularly preferred variant, the air discharge unit includes a first mounting for removably attaching the fresh air means at the driver control panel or at the external control console, the mounting being also provided, together with the mounting plate, for forming a fan housing for the blower unit. The first mounting thus fulfills a double function as it serves both for removably fastening the fresh air means and is also employed for forming the fan housing within the air discharge unit. For its actual fastening function, the first mounting includes a first section which projects from the air discharge unit. For its housing function, that means for forming the fan housing, the first mounting includes a second section which is positioned within the air discharge unit to be fastened therein at the mounting plate at a distance thereto. This results in a very stable construction, so that even a blower unit having a high speed can be stably fastened to the driver control panel or to the external control console.

According to one embodiment of the disclosure, the first mounting is removably connected to a second mounting that can be fastened to the driver control panel or to the external control console. The second mounting itself can be removably fastened to the driver control panel or to the external control console. In particular, the second mounting includes an upper section which is connected with the external section of the first mounting, for example screwed to it. The upper section of the second mounting can be connected with a lower section of the second mounting by a step form, and is in particular integrally formed with it via the step form. The lower section of the second mounting includes a mounting base by means of which the second mounting can be fastened to the substructure of the driver control panel or to the substructure of the external control console.

It is advantageous for a connection point formed between the first mounting and the second mounting to be mounted to be freely accessible for an operator above the driver control panel or the external control console. In other words, in this variant, the coupling point at which the external section of the first mounting is connected with the upper section of the second mounting is situated above the driver control panel or the external control platform such that a driver or an operator, respectively, can easily access the coupling point with tools, for example with a wrench, to mount or dismount the fresh air means to the driver control panel or to the external control console.

It is particularly practicable for the air flow sucked in by means of the blower unit through the filter unit to be distributable by the blower unit as a filtered fresh air flow to at least two flow channels formed within the air discharge unit. Via the latter, the fresh air can be transported to different points of the driver control panel or the external control console, respectively, and stream out of the air discharge unit to improve the air quality in this region for a driver or for an operator, respectively.

It would be conceivable for the air flow sucked in by means of the blower unit through the filter unit to be forwarded from the blower unit to the outlet opening as a filtered fresh air flow through one single flow channel connected with the blower unit.

In one variant, the fresh air means includes a plurality of blower units for which one flow channel each is formed separately. In other words, in this variant, the air flow emitted by each blower unit is not split but completely transported further via a flow unit connected with the blower unit.

To achieve an advantageous distribution of the fresh air at the driver control panel or at the external control platform, the flow channels can transport fresh air in particular in opposite directions to eject them at external ends through outlet openings formed thereat.

A particularly advantageous constructive design results when the internal section of the first mounting serves for forming the two flow channels at least in sections. Thereby, the first mounting could be employed at the fresh air means in a particularly versatile manner.

Preferably, the air discharge unit comprises a cover for covering the flow channels. It is possible for the cover to include a hollow space together with other components forming the flow channel or the flow channels, for example with the internal section of the first mounting, in which electronic components are optionally received. This permits to mount the electronic components isolated from the fresh air flow, that means they are largely unaffected by them. It would nevertheless be possible to guide the generated fresh air flow within the air discharge unit such that the electronic components positioned in the hollow space can be cooled thereby.

In one embodiment of the disclosure, the respective air outlet opening includes adjustable louvers. Thereby, the direction of flow of the fresh air flow can be set by the driver or the operator, respectively. The louvers could also be configured, according to one variant of the embodiment, to adjust an air volume flow.

It would be convenient for the fresh air means to be mounted to the driver control panel or to the external control console such that the air outlet opening formed thereat is positioned next to an operating surface of the driver control panel or the external control console. This at least optically provides an integral design, so that altogether a construction results where the driver control panel and the fresh air means mounted thereat, or the external control console with the fresh air means mounted thereat, merge into each other.

According to one variant of the disclosure, the fresh air means is configured for an installation and deinstallation without tools. For example, the external section of the first mounting forms, together with the upper section of the second mounting, a quick lock and is provided, for example, as a bent lever, a bayonet or a magnetic closure. A combination of an interlocking and a frictional connection would also be conceivable to provide a quick lock mounting.

In particular, the fresh air means is designed for generating fresh air flow that can be temperature-controlled. In the respective flow channels, at least one heating and/or cooling element can be arranged to this end which brings the fresh air flow to a desired temperature before it leaves the air discharge unit. It would be convenient in this context to provide at least one Peltier element in the respective flow channels to bring the fresh air flow transported therein to a desired temperature. It would be conceivable that the respective Peltier elements can be dynamically controlled on the basis of a process parameter detected at the road making machine, for example to control the fresh air flow to a desired temperature level in response to a detected ambient temperature of the road making machine.

In particular, the removable attachment of the fresh air means according to the disclosure at the driver control panel or at the external control console can be designed such that the fresh air means moves together with the driver control panel when the latter is adjusted, for example if the driver control panel is shifted transverse to the direction of travel of the road making machine, that means follows a movement of the driver control panel or the external control console to be able to provide the driver or the operator with fresh air at any time. It is in particular possible that the fresh air means fastened to the driver control panel or the external control console can be swiveled, tilted and/or shifted together with the driver control panel or the external control console, that means that the fresh air means benefits from the constructive mounting of the driver control panel or the external control console.

The disclosure furthermore relates to a road making machine which is configured in the form of a road finishing machine or a charger vehicle for a road finishing machine, wherein at least one fresh air means is removably fastened to the road making machine as a modular attachment apparatus. The fresh air means is provided as an attachment set and can be mounted, in particular across all series, to various road finishing machine types and charger vehicle types.

Preferably, the road making machine comprises a driver control platform that is open at least at its side, that means not a closed cabin structure. In one variant, the fresh air means is fastened to the driver control panel of the driver control platform configured to be open, and/or to an external control platform of the road making machine. The fresh air means is thus employed at the road making machine at a point not isolated from the environment. The fresh air means therefore contributes, at the road making machine, to additionally providing the working place with fresh air, i.e., the driver control.

### BRIEF DESCRIPTION OF THE DRAWINGS

Embodiments of the disclosure will be illustrated more in detail with reference to the following figures as examples. In the drawings:

FIG. 1 shows a road making machine configured as a road finishing machine;

FIG. 2 shows an external control console of an external control platform of the screed present at the road finishing machine of FIG. 1 in an isolated representation;

FIG. 3 shows a road making machine configured as a charger vehicle in a perspective representation;

FIG. 4 shows a driver control panel in an isolated representation with a fresh air means or device removably fastened to it;

FIG. 5 shows the assembly of FIG. 4 in a perspective representation from behind;

FIG. 6 shows a side view of the driver control panel with the fresh air means fastened to it;

FIG. 7 shows the fresh air means in an isolated representation;

FIG. 8 shows the fresh air means of FIG. 7 without cover;

FIG. 9 shows the fresh air means isolated, in a perspective representation from behind;

FIG. 10 shows a side view of the fresh air means;

FIG. 11 shows a sectional representation through the fresh air means;

FIG. 12 shows an external control console according to FIG. 2 with a fresh air means fastened to it from a first perspective; and

FIG. 13 shows the external control console with the fresh air means fastened to it from a rear view.

Equal technical components are always provided with the same reference numerals in the figures.

### DETAILED DESCRIPTION

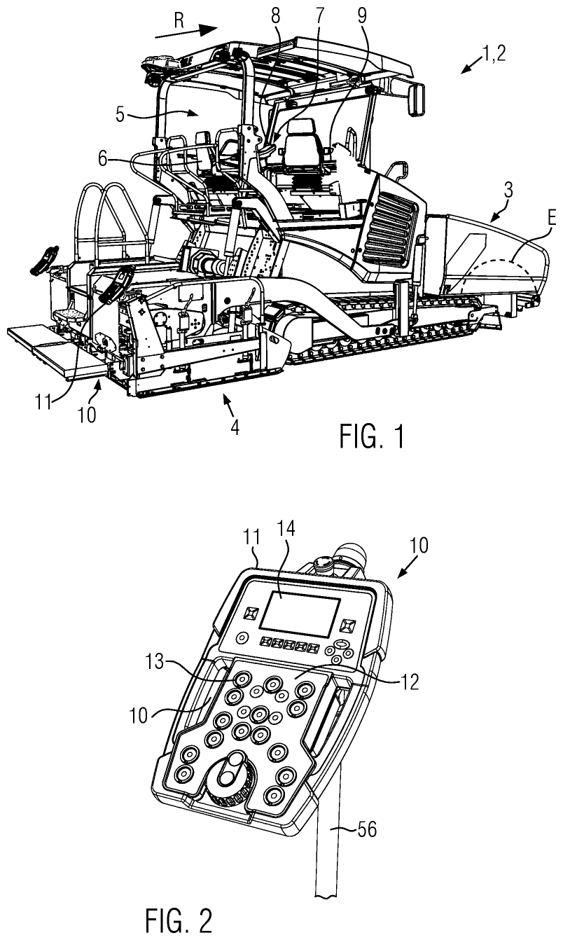

FIG. 1 shows a road making machine 1 which is present as a road finishing machine 2. The road finishing machine 2 has a material bunker 3 in which bituminous laying material E can be stored which can be processed into a new road pavement by means of a screed 4 towed by the road finishing machine 2. While the road finishing machine 2 is driving in the direction of travel R for installing the new road pavement, the laying material E is transported out of the material bunker 3, by means of a longitudinal conveying means not shown in FIG. 1, against the direction of travel R to a further, not shown transverse distributor screw which spreads the laying material E in front of the screed 4.

The road finishing machine 2 comprises a driver control platform 5 with an open design on which a driver seat 6 is positioned for a driver of the road finishing machine 2. In the direction of travel R in front of the driver seat 6, a driver control panel 7 is mounted. The driver control panel 7 offers an operating surface 8 for the driver by which the driver can control the operation of the road finishing machine 2, in particular control and/or monitor processes running at it. The driver control panel 7 shown in FIG. 1 can be adjusted along a guide path 9 transverse to the direction of travel R. To this end, the driver control panel 7 forms a suited slide which can be shifted on the guide path 9 and be fixed along the same at a desired position for the driver.

FIG. 1 furthermore shows that at external sides of the screed 4, one external control station 10, such as an external platform, is formed. At the external control station 10, an external control console 11 is fastened by means of which an operator walking along next to the screed 4 can control and/or monitor the operation of the screed 4. In particular by means of the external control console 11, an operation of the components installed in the screed 4, for example settings of compacting units and/or heating means operating therein, can be controlled.

FIG. 2 shows the external control console 11 in an isolated representation. The external control console 11 of FIG. 2 has an operating surface 12 with a plurality of buttons 13 and a display 14 for displaying process parameters adjusted at the screed 4.

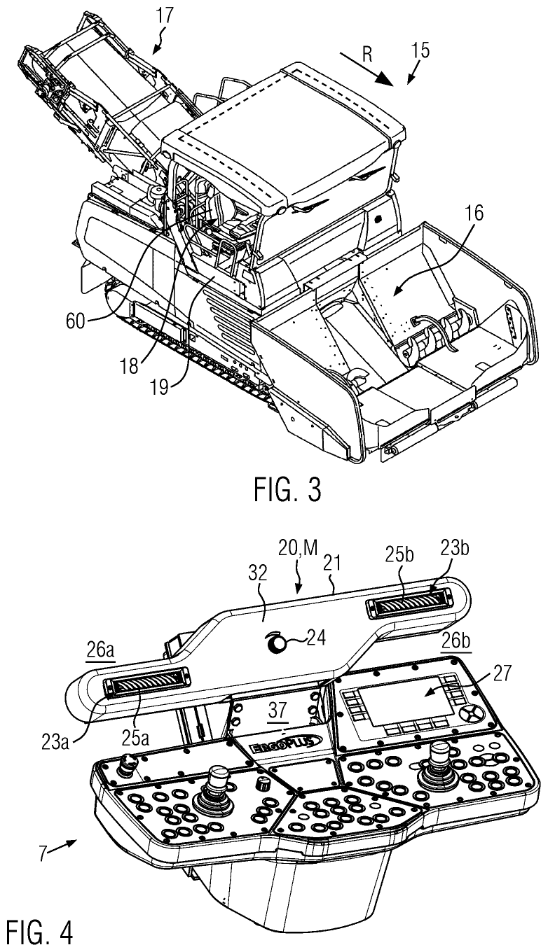

FIG. 3 shows a charger vehicle 15. Such a charger vehicle 15 can drive in front of the road finishing machine 2 shown in FIG. 1 during the production of a new paving layer and provide it with laying material E. The charger vehicle 15 has a material bunker 16 from which the laying material E can be transported, by means of a longitudinal conveying means 17, into the material bunker 3 of the road finishing machine 2 driving behind in the direction of travel R.

The charger vehicle 15 has a driver control platform 18 with an open design on which a driver seat 60 as well as a driver control panel 19 mounted in front of the driver seat 60 in the direction of travel R is provided. The driver control panel 19 can approximately have the constructive dimensioning of the driver control panel 7 of the road finishing machine 2 of FIG. 1. An operating surface provided at the driver control panel 19 is, of course, configured in view of the functions of the charger vehicle 15.

FIG. 4 shows, in an isolated representation, the driver control panel 7 of the road finishing machine 2 with a fresh air means or device 20 removably attached to it. Instead of the driver control panel 7, the driver control panel 19 of the charger vehicle 15 could also be employed as a fastening point for removably attaching the fresh air means 20. Moreover, the external control console 11 of FIG. 2 would also be possible as a fastening point for removably attaching the fresh air means 20. The fresh air means 20 then optionally has a constructive design adapted for the external control console 11.

The fresh air means 20 present in FIG. 4 is a modular attachment apparatus M for removably fastening it to the driver control panel 7, that means it could also be easily dismounted from the driver control panel 7 without affecting the functioning of the driver control panel 7 thereby.

The fresh air means 20 of FIG. 4 comprises an air discharge unit 21 with a cover 22. The air discharge unit 21 has two air outlet openings 23a, 23b through which fresh air flows into the region of the driver who is positioned in front of the driver control panel 7. The power of a fresh air flow provided from the air outlet openings 23a, 23b can be adjusted by means of an operating element 24 (e.g., dial, knob, or button) formed in the cover 22. FIG. 4 further shows that the air outlet openings 23a, 23b each comprise louvers 25a, 25b which serve to adjust a direction of flow of the fresh air. The louvers 25a, 25b could optionally be designed to adjust an air volume flow formed through the air outlet openings 23a, 23b.

It is shown in FIG. 4 that the cover 22 of the air discharge unit 21 forms a recess 26a above the air outlet opening 23a, and a further recess 26b below the air outlet opening 23b. The respective recesses 26a, 26b take care of a compact design of the air discharge unit 21. In particular, the recess 26b gives the driver a good view onto the display 27 formed under it, at the driver control panel 7, to be able to monitor process parameters of the road making machine 1 adjusted thereat. By the recess 26a, the driver can better view over and beyond the air discharge unit 20, for example to monitor a material filling level in the material bunker 3 of the road finishing machine 2.

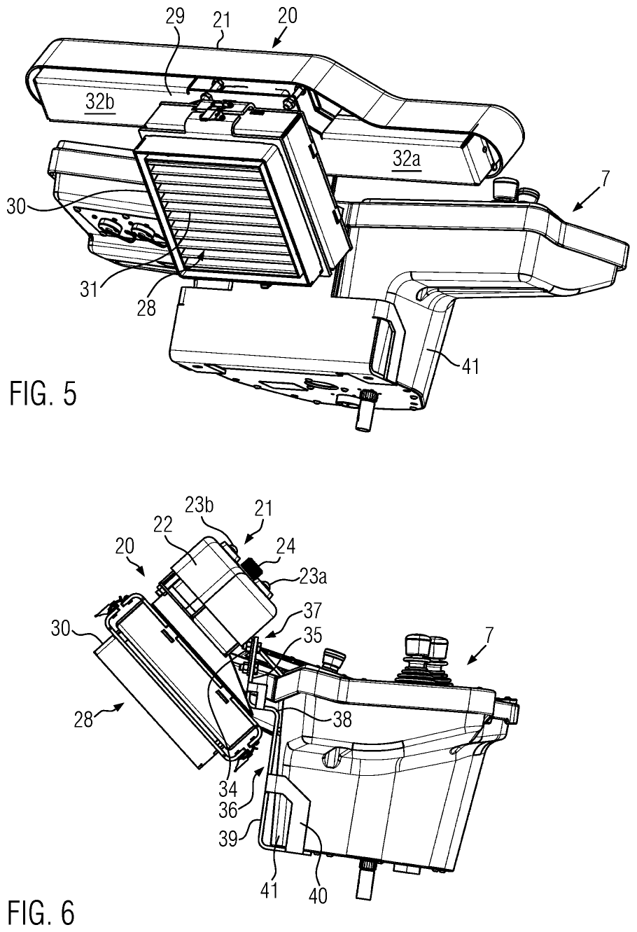

FIG. 5 shows the attachment of the modular fresh air means 20 represented in FIG. 4 at the driver control panel 7 from a rear perspective. The fresh air means 20 of FIG. 5 has a filter unit 28 which is fastened on the rear side of the air discharge unit 21 at a mounting plate 29 positioned at it. The filter unit 28 has a filter housing 30 in which a filter element 31 is received. FIG. 5 furthermore shows that the mounting plate 29 forms lateral projections 32a, 32b.

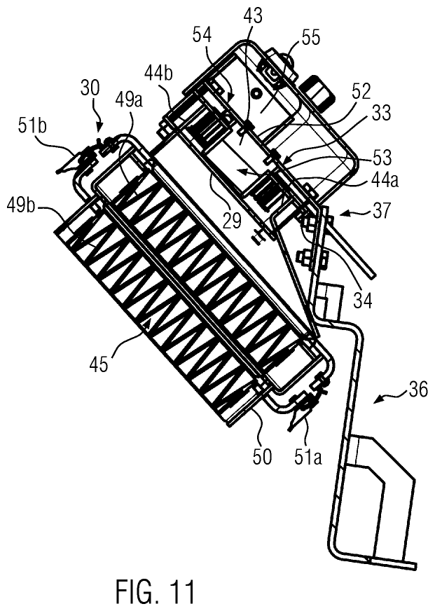

FIG. 6 shows a side view of the modular assembly of FIG. 5. The air discharge unit 21 has a first mounting 33 (see FIG. 11) with an external section 34 which is screwed to an upper section 35 of a second mounting 36. A connection point 37 formed between the external section 34 of the first mounting 33 and the upper section 35 of the second mounting 36, as can in particular also be seen in FIG. 4, is positioned above the driver control panel 7, freely accessible for the driver, so that he or she can easily attach or detach the fresh air means 20 at the driver control panel 7. The second mounting 36 can remain at the driver control panel 7 or also be detached from the driver control panel 7.

FIG. 6 furthermore shows that the upper section 35 of the second mounting 36 is connected with a lower section 39 by means of a step form 38. The upper section 35, the step form 38 and the lower section 39 can be present as an integrally manufactured form part, for example be bent from a sheet blank. At the lower section 39, a mounting base 40 is formed which is present corresponding to a constructive design of a substructure 41 formed at the driver control panel 7 to be attached thereto by positive engagement.

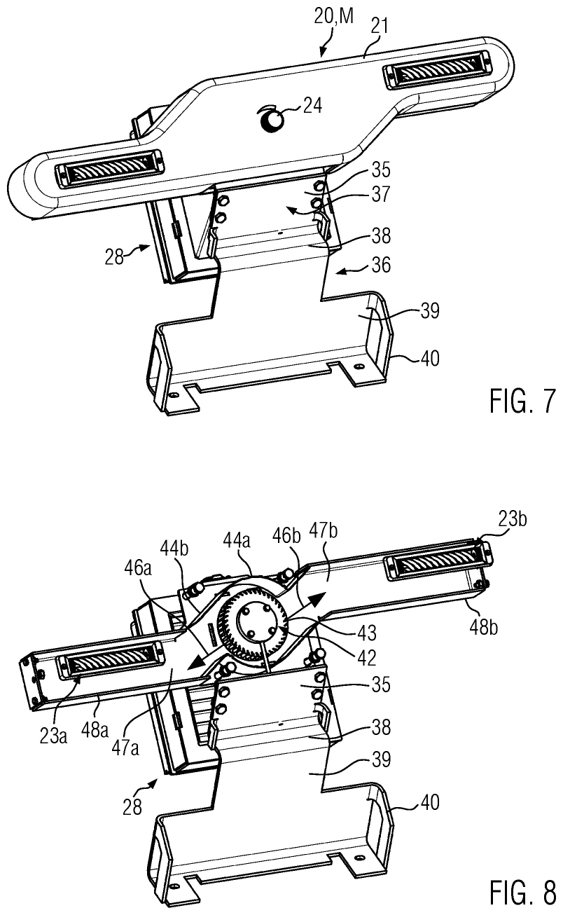

FIG. 7 shows the fresh air means 20 including the second mounting 36 fastened thereto in an isolated representation. In this configuration, or as an alternative without the second mounting 36, the fresh air means 20 is present as a modular attachment apparatus M which can be easily attached and detached, in particular to various types of road finishing machines, to a driver control panel 7 provided at it to supply the driver with fresh air. Even if the respective types of road finishing machines have slightly differing driver control panels 7, the second mounting 40 could be present and correspondingly adapted, so that the substantial construction of the fresh air means 20 is applicable as a standard attachment apparatus across all series.

FIG. 8 shows the fresh air means 20 of FIG. 7 without cover 22. FIG. 8 shows that on a side of the mounting plate 29 facing away from the filter unit 28, a blower unit 42 is arranged. The blower unit 42 is present as a centrifugal fan 43.

The centrifugal fan 43 is surrounded by fresh air guiding profiles 44a, 44b positioned on the mounting plate 29. An air flow 45 axially sucked in through the filter unit 28 by means of the centrifugal fan 42 (cf. FIG. 11) is radially distributed by the centrifugal fan 43 to the two flow channels 47a, 47b shown in FIG. 8 as a filtered fresh air flow 46a, 46b. The fresh air flow 46a, 46b will exit through the two air outlet openings 23a, 23b into the region of the driver control platform 5 of the road finishing machine 2 whereby the air quality on the control platform 5 is improved for the driver.

According to FIG. 8, the two air outlet openings 23a, 23b are formed in respective plate parts 48a, 48b which are integrated, in the assembled state of the fresh air means 20, in the cover 22 (cf. FIG. 11).

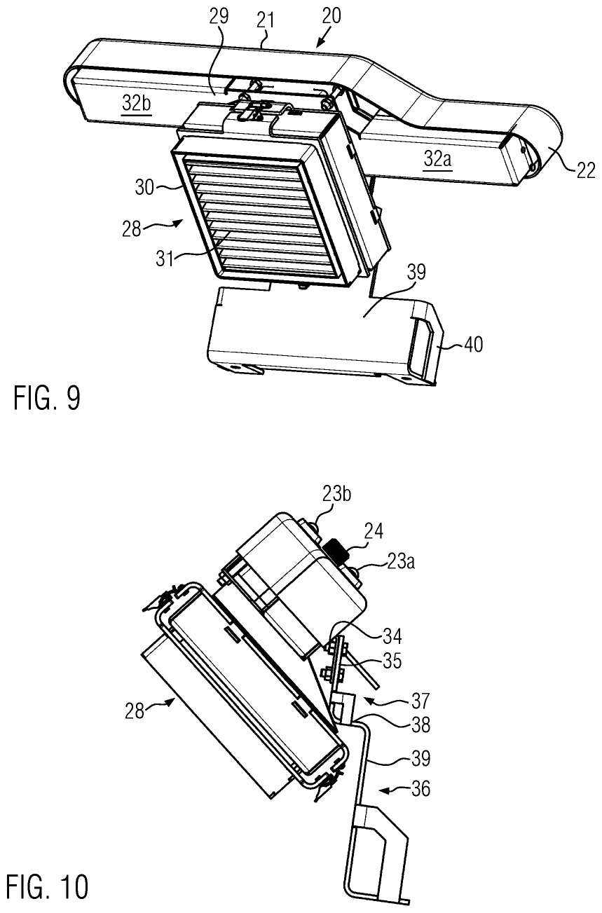

FIG. 9 basically shows the representation of FIG. 5, only without the driver control console 7. Therefore, FIG. 9 shows the fresh air means 20 in an isolated representation from behind.

FIG. 10 basically shows the representation of FIG. 6, only without the driver control console 7, wherein the fresh air means 20 is shown in a side view.

FIG. 11 shows a sectional representation of the fresh air means 20. One can see in FIG. 11 that the filter housing 30 receives both a first filter element 49a and a second, further filter element 49b. The two filter elements 49a, 49b are arranged in series in the direction of the axial air flow 45 one behind the other to create an additional filter effect. The second filter element 49b can be supported by means of a housing expansion stage 50 fastened to the filter housing 30. The housing expansion stage 50 is fastened at the filter housing 30 by means of quick locks 51a, 51b in FIG. 11.

According to FIG. 11, the first mounting 33 includes, apart from the external section 34, also an internal section 52 which is fastened to the mounting plate 29 spaced apart from the latter. A blower accommodation space 53 in which the centrifugal fan 43 is positioned is formed between the internal section 52 and the mounting plate 29. FIG. 11 in particular shows that the internal section 52 of the first mounting 33 forms, together with the mounting plate 29 and the air guiding profiles 44a, 44b, a fan housing 44 for the centrifugal fan 43.

FIG. 11 furthermore shows that between the cover 22 and the internal section 52 of the first mounting 33, a hollow space 55 is formed in which electronic components can be received.

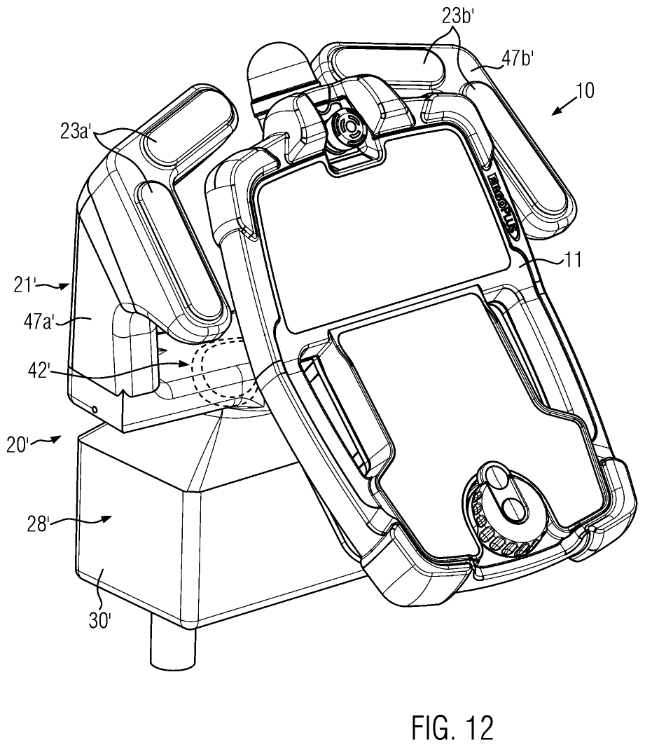

FIG. 12 shows the external control console 11 of FIG. 2 with a fresh air means or device 20′ mounted thereto. The fresh air means 20′ has a filter unit 28′ which comprises, according to FIG. 12, a box-shaped filter housing 30′. An air discharge unit 21′ connected with the filter housing 30′ is positioned above the filter housing 30′. A blower unit 42′ which is positioned between the filter unit 28′ and the air discharge unit 21′ is indicated in a dashed line. The blower unit 42′ can be completely received within the air discharge unit 21′ according to the design of the fresh air means 20.

FIG. 12 furthermore shows that the air discharge unit 21′ forms two flow channels 47a′, 47b′ leading away from the blower unit 42′ mounted therein. The two flow channels 47a′, 47b′ form air outlet openings 23a′, 23b′ from which fresh air exits for an operator positioned at the external control platform 10.

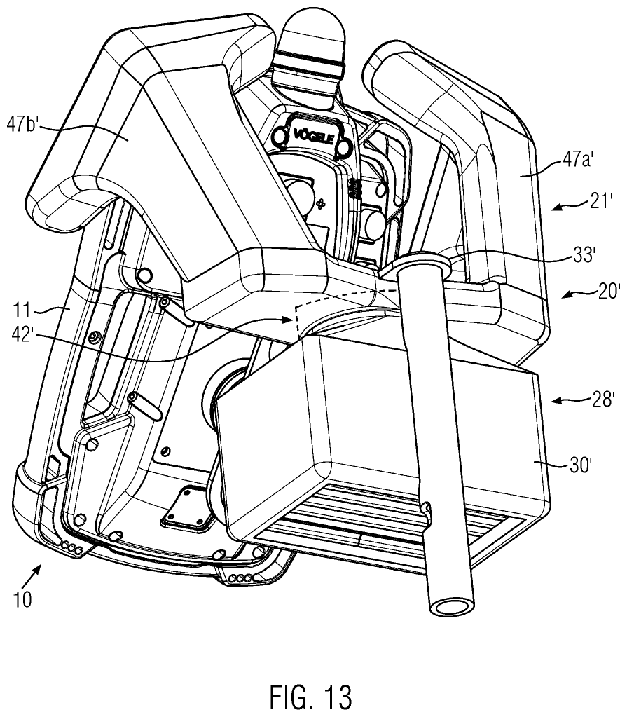

FIG. 13 shows the construction of FIG. 12 from a perspective from behind.

The fresh air means 20′ includes a mounting 33′ by means of which it is fastened to a tube 56 of the external control station 10. While the mounting 33′ for fastening the fresh air means 20′ is shown here, it would absolutely be conceivable to mount the fresh air means 20′ with a comparable fastening technique to that of the fresh air means 20, i.e., using a first mounting and a second mounting according to the first mounting 33 and the second mounting 36. The fastening of the blower unit 42′ can be designed similar to the fastening of the blower unit 42, in particular corresponding to the construction of FIG. 11.

It can be easily seen in FIG. 13 that the fresh air means 20′ forms an attachment module M′ for the external control console 11 which can be perfectly attached, in particular retrofitted, at the external control station 10—just as the fresh air means 20 on the driver control platform 5.

What is claimed is:

1. A fresh air device for a driver control panel or for an external control console of a road making machine which is configured as a road finishing machine or a charger vehicle for a road finishing machine, wherein the fresh air device comprises a blower unit for generating an air flow, a filter unit for filtering the air flow formed by the blower unit, and an air discharge unit including at least one air outlet opening for the filtered air flow, wherein the fresh air device is designed as a modular attachment apparatus configured to be removably attached to the driver control panel or to the external control console.

2. The fresh air device according to claim 1, wherein the blower unit includes a centrifugal fan or an axial-flow fan.

3. The fresh air device according to claim 1, wherein the blower unit is connectable with a power supply source of the road making machine, and/or the fresh air device includes at least one separate accumulator for an operation of the blower unit.

4. The fresh air device according to claim 1, wherein the air discharge unit includes at least one operating element for adjusting a speed of the blower unit.

5. The fresh air device according to claim 1, wherein the filter unit is positioned upstream of the blower unit seen in a direction of flow, and/or the filter unit includes a filter housing for receiving a replaceable filter element.

6. The fresh air device according to claim 5, wherein the filter unit comprises at least one housing expansion stage for the filter housing that is configured to receive at least one further filter element.

7. The fresh air device according to claim 1, wherein the air discharge unit includes a mounting plate to which the blower unit and/or the filter unit is fastened.

8. The fresh air device according to claim 7, wherein the air discharge unit includes a first mounting for removably attaching the fresh air device at the driver control panel or at the external control console, the first mounting being also provided, together with the mounting plate, for forming a fan housing for the blower unit.

9. The fresh air device according to claim 8, wherein the first mounting is removably connected with a second mounting that is fastenable to the driver control panel or the external control console.

10. The fresh air device according to claim 9, wherein a connection point formed between the first mounting and the second mounting is mounted to be freely accessible by an operator above the driver control panel or the external control console.

11. The fresh air device according to claim 1, wherein the air flow sucked in through the filter unit by the blower unit is distributable by the blower unit as a filtered fresh air flow to at least two flow channels formed within the air discharge unit.

12. The fresh air device according to claim 11, wherein the at least one air outlet opening of the air discharge unit comprises first and second air outlet openings, and the at least two flow channels comprise first and second flow channels that are designed to guide the filtered fresh air flow generated by the blower unit in opposite directions to the first and second outlet openings, respectively, of the air discharge unit.

13. The fresh air device according to claim 11, wherein the air discharge unit comprises a cover for covering the at least two flow channels.

14. The fresh air device according to claim 11, wherein the at least one air outlet opening includes adjustable louvers.

15. The fresh air device according to claim 1, wherein the fresh air device is mountable to the driver control panel or to the external control console such that the at least one air outlet opening formed thereat is positioned next to an operating surface of the driver control panel or the external control console.

16. A road making machine which is configured as a road finishing machine or a charger vehicle for a road finishing machine, comprising the fresh air device according to claim 1.

17. The road making machine according to claim 15, further comprising a driver control platform and an external control platform, wherein the driver control platform is open at least at a side and includes a driver control console, and wherein the fresh air device is fastened to the driver control console or to the external control platform.
